(19) United States
(12) Patent Application Publication
(10) Pub. No.: US 2026/0281826 A1
(43) Pub. Date: Sep. 17, 2026

(54) MOBILITY BETWEEN WIRELESS COMMUNICATION NETWORKS

(71) Applicant: Lenovo (Singapore) Pte. Limited, Singapore (SG)

(72) Inventors: Roozbeh Atarius, La Jolla, CA (US); Dimitrios Karampatsis, Ruislip (GB)

(73) Assignee: Lenovo (Singapore) Pte. Limited, Singapore (SG)

(21) Appl. No.: 19/473,251

(22) PCT Filed: May 12, 2023
(86) PCT No.: PCT/EP2023/062715

§ 371 Date: Oct. 7, 2025

(30) Foreign Application Priority Data
Apr. 7, 2023 (GR) 20230100296

(51) Int. Cl. H04W 36/00; H04W 48/16

(52) U.S. Cl. CPC H04W 36/0022; H04W 48/16

(57) ABSTRACT

There is further provided a method in a wireless communication device, the method comprising: transmitting, to a first network function, an information element, the information element comprising: a first container comprising a UE STATE INDICATION message; and a second container comprising a PDU session identity. The UE STATE INDICATION message comprises an UPSI list; and an indication for ANDSP support. The information element indicates that a PDU session identified by the PDU session identity is to be transferred from a first mobile communications technology to a second communications technology.

### FIELD

The subject matter disclosed herein relates generally to the field of implementing mobility between wireless communication networks. This document defines a wireless communication device, a method in a wireless communication device, a second network function, and a method in a second network function.

### INTRODUCTION

A wireless communication device such as a UE may be able to connect to and communicate via both a 5^{th} Generation System (5GS) and an Evolved Packet System (EPS). Such a UE can register to the 5GS and also attach to EPS via single registration or via dual registrations, and can be capable of receiving UE policy sections in EPS as well as in 5GS. In the case of single registration to 5GS, if the UE supports UE policy sections including the URSP in EPS, and handovers a PDU session from the 5GS to EPS, then the SM-PCF needs to establish the UE policy association with the UE-PCF, so as to assign the right policies to the PDU session after the handover. When the UE handovers from the 5GS to EPS, at the time of release of the PDU session, it is not clear how long the UE-PCF will maintain the existing UE policy association while the UE is registered to 5GS. Therefore, by the time the UE attaches to the EPS to establish the PDN connection, the existing UE policy associations in 5GS may be terminated, and as a result the PDU session cannot be handed-over to the EPS. This network behavior is problematic if the network does not support N26.

### SUMMARY

There is presented herein a new interaction between the UE and the AMF/SMF+PWG-C for a handover of a PDU session from a 5GS to an EPS. This is particularly useful when the network does not use the optional N26 interface.

Disclosed herein are procedures for mobility between wireless communication networks. Said procedures may be implemented by a wireless communication device, a method in a wireless communication device, a second network function, and a method in a second network function.

Accordingly, there is provided a wireless communication device, comprising: a processor; and a memory coupled with the processor. The processor is configured to cause the wireless communication device to: transmit, to a first network function, an information element, the information element comprising: a first container comprising a UE STATE INDICATION message; and a second container comprising a PDU session identity. The UE STATE INDICATION message comprises an UPSI list; and an indication for ANDSP support. The information element indicates that a PDU session identified by the PDU session identity is to be transferred from a first mobile communications technology to a second communications technology.

There is further provided a method in a wireless communication device, the method comprising: transmitting, to a first network function, an information element, the information element comprising: a first container comprising a UE STATE INDICATION message; and a second container comprising a PDU session identity. The UE STATE INDICATION message comprises an UPSI list; and an indication for ANDSP support. The information element indicates that a PDU session identified by the PDU session identity is to be transferred from a first mobile communications technology to a second communications technology.

There is further provided a second network function, comprising: a processor; and a memory coupled with the processor. The processor is configured to cause the second network function to: receive, from a wireless communication device, an information element, the information element comprising a first container comprising a UE STATE INDICATION message and a second container comprising a PDU session identity, wherein the UE STATE INDICATION message comprises an UPSI list and an indication for ANDSP support. The processor is further configured to cause the second network function to determine that the wireless communication device supports a policy association; request that a third network function establishes a policy association for the wireless communication device; create a policy sections management list by using the policy association established for the wireless communication device; and transmit to the wireless communication device the policy sections management list.

There is further provided a method in a second network function, the method comprising: receiving, from a wireless communication device, an information element, the information element comprising a first container comprising a UE STATE INDICATION message and a second container comprising a PDU session identity, wherein the UE STATE INDICATION message comprises an UPSI list, and an indication for ANDSP support. The method further comprises: determining that the wireless communication device supports a policy association; requesting that a third network function establishes a policy association for the wireless communication device; creating a policy sections management list by using the policy association established for the wireless communication device; and transmitting to the wireless communication device the policy sections management list.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for mobility between wireless communication networks will now be described, by way of example only, with reference to the accompanying drawings, in which:

FIG. 1 depicts an embodiment of a wireless communication system for providing mobility between wireless communication networks;

FIG. 2 depicts a user equipment apparatus that may be used for implementing the methods described herein;

FIG. 3 depicts further details of the network node that may be used for implementing the methods described herein;

FIG. 4 illustrates a network architecture with a capability to transmit policy sections to a UE;

FIG. 5 illustrates a process for the UE's mobility from 5GS to EPS when the N26 interface is not supported by the AMF and the MME;

FIG. 6 illustrates a method in a wireless communication device; and

FIG. 7 illustrates a method in a second network function.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of′ includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of′ includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

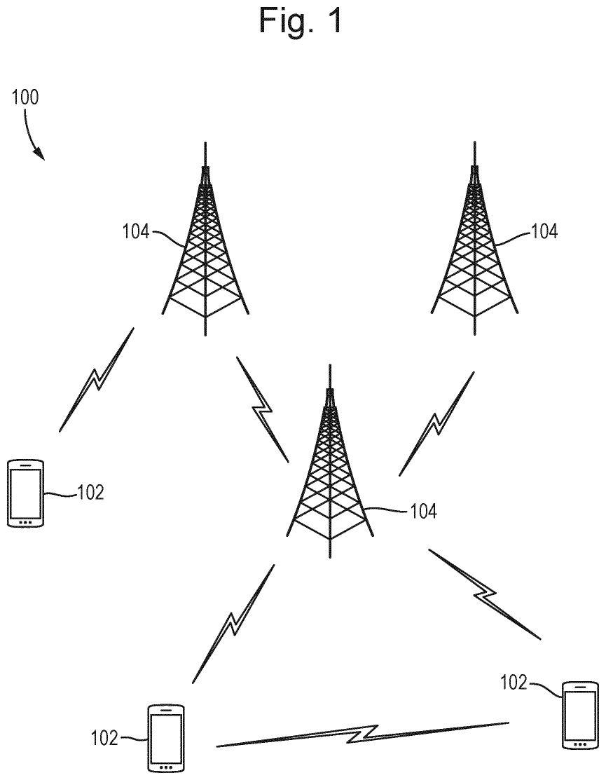

FIG. 1 depicts an embodiment of a wireless communication system 100 for providing mobility between wireless communication networks. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The wireless communication system may comprise a wireless communication network and at least one wireless communication device. The wireless communication device is typically a 3GPP User Equipment (UE). The wireless communication network may comprise at least one network node. The network node may be a network unit.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF″), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfox, LoraWAN among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

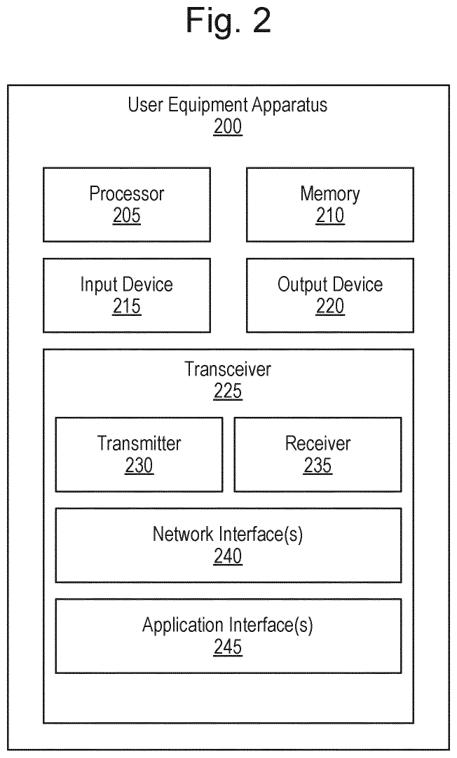

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a wireless communication device, a remote unit 102, and/or a UE 410, 411, 510 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module.

Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

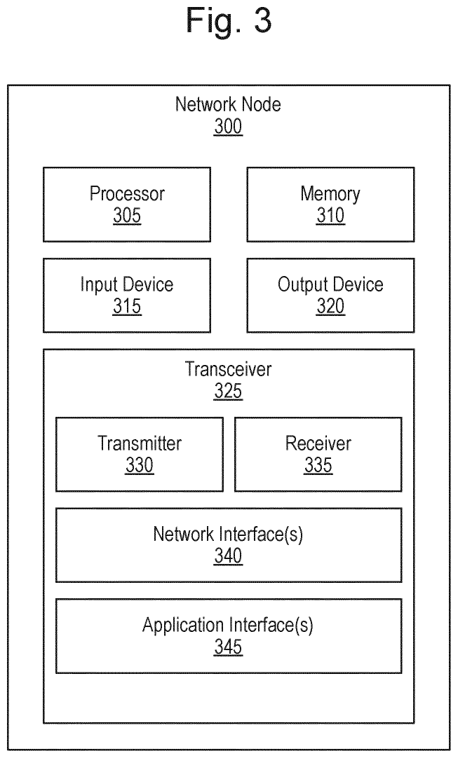

FIG. 3 depicts further details of the network node 300 that may be used for implementing the methods described herein. The network node 300 may be one implementation of an entity in the wireless communication network, e.g. in one or more of the wireless communication networks described herein. The network node 300 may comprise a second network function, a network unit 104, network node 300, and/or an SM-PCF 430, 530 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

A wireless communication device such as a UE may be able to connect to and communicate via both a 5^{th} Generation System (5GS) and an Evolved Packet System (EPS). Such a UE can register to the 5GS and also attach to EPS via single registration or via dual registrations, and can be capable of receiving UE policy sections in EPS as well as in 5GS. In the case of single registration to 5GS, if the UE supports UE policy sections including the URSP in EPS, and handovers a PDU session from the 5GS to EPS, then the SM-PCF needs to establish the UE policy association with the UE-PCF, so as to assign the right policies to the PDU session after the handover. When the UE handovers from the 5GS to EPS, at the time of release of the PDU session, it is not clear how long the UE-PCF will maintain the existing UE policy association while the UE is registered to 5GS. Therefore, by the time the UE attaches to the EPS to establish the PDN connection, the existing UE policy associations in 5GS may be terminated, and as the result the PDU session cannot be handed-over to the EPS. This network behavior is problematic if the network does not support N26.

N26 is an inter-core network interface, for example between AMF and MME, and may be used to enable interworking between the 5G core and EPC. However, support of the N26 interface in the network is optional. Interworking procedures using N26 interface enable the exchange of MM and SM states between the source and target networks, and as such handover procedures may be supported through the N26 interface.

The N26 interface between AMF in 5GC and MME in EPC may be used to enable seamless session continuity for inter-system handover which may be particularly of use for delivering voice services. Using N26 may result in reduced voice interruption time when, for example, performing a handover between 5G (VoNR) to 4G (VOLTE).

There is presented herein a new interaction between the UE and the AMF/SMF+PWG-C for a handover of a PDU session from a 5GS to an EPS. This is particularly useful when the network does not use the optional N26 interface.

3GPP TS 24.501 v18.1.0 titled “Non-Access-Stratum (NAS) protocol for 5G System (5GS); Stage 3; (Release 18)” describes at section D.2.2 a UE-initiated UE state indication procedure, which is a procedure performed at the time of initial registration to the 5GS. Section D.2.2.1 of 3GPP TS 24.501 v18.1.0 states that the purpose of the UE-initiated UE state indication procedure is as follows.

The purpose of the UE-initiated UE state indication procedure is:
a) to deliver the UPSI(s) of the UE policy section(s) which are:
   identified by a UPSI with the PLMN ID part indicating the HPLMN or the selected PLMN, and stored in the UE, if any; or
   identified by a UPSI with the PLMN ID part indicating the PLMN ID part of the SNPN identity of the selected SNPN and associated with the NID of the selected SNPN, and stored in the UE, if any;
b) to indicate whether UE supports ANDSP; and
c) to deliver the UE's one or more OS IDs;
to the PCF.

Section D.2.2.2 of 3GPP TS 24.501 v18.1.0 describes UE-initiated UE state indication procedure initiation as follows.

In order to initiate the UE-initiated UE state indication procedure, the UE shall create a UE STATE INDICATION message. The UE:
a) shall allocate a PTI value currently not used and set the PTI IE to the allocated PTI value;
b) if not operating in SNPN access operation mode, shall include the UPSI(s) of the UE policy section(s) which are identified by a UPSI with the PLMN ID part indicating the HPLMN or the selected PLMN available in the UE in the UPSI list IE;
c) if operating in SNPN access operation mode, shall include UPSI(s) of the UE policy section(s) which are identified by a UPSI:
   with the PLMN ID part indicating the MCC and MNC of the selected SNPN; and
   associated with the NID of the selected SNPN; available in the UE in the UPSI list IE;
d) shall specify whether the UE supports ANDSP in the UE policy classmark IE; and
e) may include the UE's one or more OS IDs in the UE OS Id IE.

The UE shall send the UE STATE INDICATION message (see example in figure D.2.2.2.1). The UE shall transport the created UE STATE INDICATION message using the registration procedure (see subclause 5.5.1).

Section D.2.2.3 of 3GPP TS 24.501 v18.1.0 describes the UE-initiated UE state indication procedure accepted by the network. This explains that upon receipt of the UE STATE INDICATION message, the PCF shall operate as described in 3GPP TS 23.502 v18.1.0 titled “Procedures for the 5G System (5GS)” and 3GPP TS 29.525 v18.1.0 titled “5G System; UE Policy Control Service; Stage 3”.

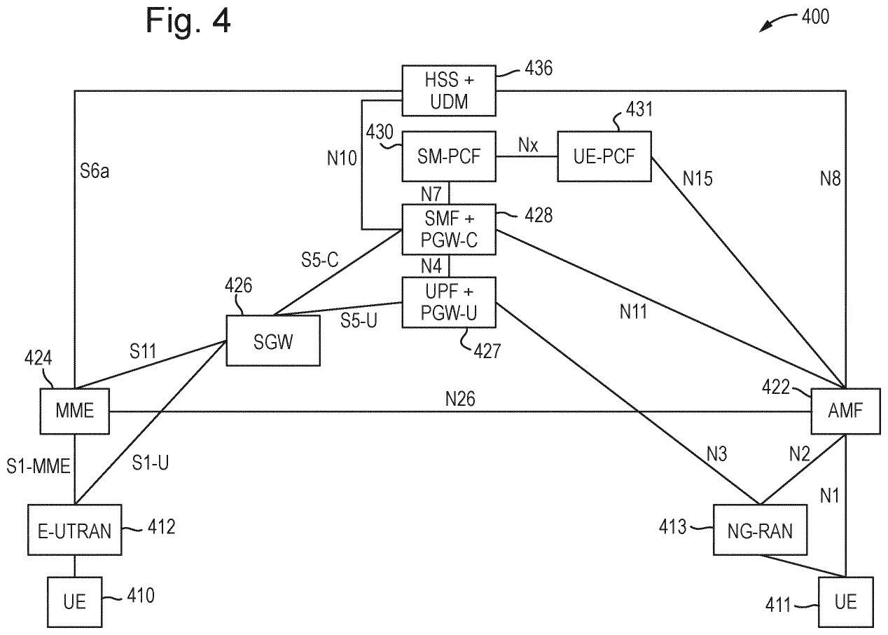

A 3GPP working item for enhanced UE policy (eUEPO) allows the UE to receive UE policy sections when the UE registers to an EPS network. FIG. 4 illustrates the network architecture 400 with the capability to transmit policy sections to the UE.

The network architecture 400 comprises a UE 410 that communicates via an E-UTRAN 412 and a Mobility Management Entity (MME) 424. The network architecture 400 further comprises a UE 411 that communicates with a Next Generation Radio Access Network (NG-RAN) 413 and an Access and Mobility Management function (AMF) 422. MME 424 and E-UTRAN 412 communicates with a Serving Gateway (SGW) 426, which in turn communicates with Session Management function (SMF)+Packet Data Network Gateway-Control (PGW-C) 428 and User plane function (UPF)+Packet Data Network Gateway-User (PGW-U) 427. AMF 422 and NG-RAN 413 also communicate with SMF+PGW-C 428 and User plane function (UPF)+Packet Data Network Gateway-User (PGW-U) 427. The network architecture 400 further comprises a Session Management Policy Control Function (SM-PCF) 430, a Home Subscriber Server (HSS)+Unified Data Management (UDM) 436 and a User Equipment Policy Control Function (UE-PCF) 431. The interfaces between the various network functions are also shown in FIG. 4.

The UEs 410, 411 may each comprise a wireless communication device, a remote unit 102, a user equipment apparatus 200, and/or a UE 510 as described herein. The SM-PCF 430 may comprise a second network function, a network unit 104, a network node 300, or an SM-PCF 530 as described herein.

The UE 410, at the time of attach to the EPS (here, E-UTRAN 412), requests establishment of a PDN connectivity. Further, by using an extended protocol configuration options (ePCO), the UE 410 transmits the UE STATE INDICATION message to the SMF+PGW-C 428 which will later be forwarded to SM-PCF 430 to establish a UE policy associations with UE-PCF 431 in order to provide the UE policy sections.

The SM-PCF 430 does not support N15 reference point while the UE-PCF 431 does not support N7 reference point. In this arrangement, for URSP delivery from UE-PCF 431 in 5GC to the UE 410 in EPS, the UE Policy Association establishment between SM-PCF 430 and UE-PCF 431 is provided. The URSP can be transparently delivered to the UE 410 via SM-PCF 430, SMF+PGW-C 428, SGW 426, and MME 424. As depicted in FIG. 4, an interface (Nx) needs to be specified between SM-PCF 430 and UE-PCF 431 for establishing a UE Policy Association. The N15 interface can be reused as Nx. When the UE 410 sends an Attach Request in EPS (e.g. Initial Attach procedure, 5GS to EPS Mobility procedure without N26), the UE 410 sends UE Policy Container including list of PSIs and URSP delivery over EPS Indication in PCO to UE-PCF 431. When the UE policy has been updated in the UE-PCF 431 while the UE 410 is in EPS, the UE-PCF 431 sends the UE Policy Container to SMF+PGW-C 428. The SMF+PGW-C 428 sends PCO including UE Policy Container to the UE 410. Further, when the UE 411 sends a Registration Request in 5GS, UE Policy Container including list of PSIs and URSP delivery over EPS Indication to UE-PCF 431. In 5GS to EPS Handover/Idle mode mobility using N26, the UE Policy Association established in 5GS can be maintained in EPS.

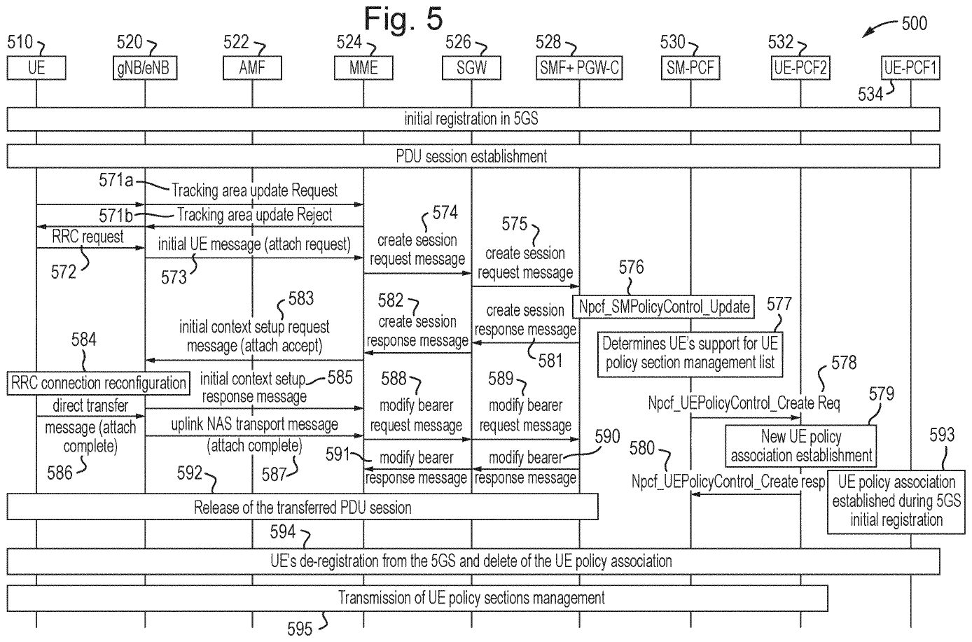

FIG. 5 illustrates a process 500 for the UE's mobility from 5GS to EPS when the N26 interface is not supported by the AMF and the MME. The process 500 is performed by a UE 510, 1 gNB and/or an eNB 520, an AMF 522, an MME 524, an SGW 526, an SMF+PGW-C 528, and SM-PCF 530, a UE-PCF2 532 and a UE-PCF1 534.

The UE 510 may comprise a wireless communication device, a remote unit 102, a user equipment apparatus 200, and/or a UE 410, 411 as described herein. The SM-PCF 530 may comprise a second network function, a network unit 104, a network node 300, and/or an SM-PCF 430 as described herein.

Assumed pre-conditions for the process 500 are:
The UE is initially registered in 5GS with a PDU session and the UE is operating in single registration mode.
The UE has already included a UE state indication message when registering to 5GS and include a capability to support UE policy sections management including the URSP provisioning in EPS.
The capability to support URSP provisioning in EPS is stored in the UDR for the UE.
The N26 interface is not supported.

The process 500 begins at 571 where, due to the coverage of 5GS, a trigger tracking area may occur that the UE 510 initiates to perform the tracking area update procedure with SGW 526 change as described in clause 5.3.3.1 of 3GPP TS 23.401 v18.1.0 “General Packet Radio Service (GPRS) enhancements for Evolved Universal Terrestrial Radio Access Network (E-UTRAN) access”. The UE 510 provides an EPS-GUTI that is mapped from the 5G-GUTI and the MME 524 determined that the old node is an AMF 522 based on the UE's GUTI mapped from 5G-GUTI and the MME 524 is configured to support 5GS-EPS interworking without N26 procedure, the MME 524 sends a TAU Reject to the UE 510.

At 572, the UE 510 initiates the initial attach procedure with PDN connectivity as described in step 1 of FIG. 5.3.2.1-1 of 3GPP TS 23.401 and performing the UE initiated UE state indication procedure by including the UE STATE INDICATION message comprising:
a) the UPSI list;
b) the UE's support for ANDSP; and
c) possibly the supporting OS Ids, in an extended protocol configuration options (ePCO). The UE also includes the identity of any PDU session which is to be transferred from the 5GS to UPS in the ePCO. The UE STATE INDICATION message may be contained in an RRC request.

The RRC request may be an attach request. The RRC request may comprise: handover, ePCO. The ePCO may comprise PDU session ID and UE STATE INDICATION message.

At 573, the eNB 520 selects the MME 524 as described in step 2 of FIG. 5.3.2.1-1 of 3GPP TS 23.401.

At 574, the MME 524 selects an SGW 526 for the uplink traffic on S1_U reference point and exchanges create session request and create session response messages. The MME 524 selects Serving GW (SGW 526) based on network topology, i.e. the selected SGW 526 serves the UE's location and for overlapping SGW 526 service areas, the selection may prefer SGWs with service areas that reduce the probability of changing the serving GW. If the MME 524 supports ePCO, extended PCO support indication is set to 1 on S11 interface by the MME 524 to inform the SGW 526 is supported by the UE 510 and MME 524 as described in 3GPP TS 29.274 v18.2.0 “3GPP Evolved Packet System (EPS); Evolved General Packet Radio Service (GPRS); Tunnelling Protocol for Control plane (GTPv2-C); Stage 3” and uses create session request message to send to the SGW 526.

At 575, the SGW 526 creates a new entry in its EPS bearer context table and sends create session request message comprising APN, serving GW address, PDN address, subscribed APN and protocol configuration options towards the SMF+PGW-C 528 indicated by the SMF+PGW-C address received in the previous step. If the SGW 526 supports ePCO, the SGW set extended PCO support indication to 1 on S5/S8 interface as described in 3GPP TS 29.274 to show the support for ePCO by the UE 510, MME 524 and SGW 526 to the SMF+PGW-C 528.

At 576, upon receipt of the create session request message and realizing that the included ePCO IE comprises:
the UE STATE INDICATION message; and
the PDU session ID, the SMF+PGW-C 528 determines that the PDN connection is for transferring the PDU session with the identity equal to the PDU session ID from 5GS to EPS and constructs an HTTP POST request comprising:
the UE STATE INDICATION message; and in order to transfer the UE STATE INDICATION message from SMF+PGW-C 528 to the SM-PCF 530, a new attribute such as UeStateIndReq for:
the type SmPolicyContextData in Table 5.6.2.3-1 of 3GPP TS 29.512 v18.1.0 “5G System; Session Management Policy Control Service; Stage 3”] for when the UE attaches to the EPS without handover from the 5GS; and
the type SmPolicyUpdateContextData in Table 5.6.2.19-1 of 3GPP TS 29.512 for when the UE attaches to the EPS after the handover from the 5GS where the SMF+PGW-C 528 receives the UE STATE INDICATION message and needs to pass on to the SM-PCF 530 such as in the case where there is no N26 reference point.

The new attribute, UeStateIndReq, can be defined according to Table 1 below.

TABLE 1
Definition of the UeStateIndReq attribute.

| | | | | | |
|---|---|---|---|---|---|
| Attribute name | Data type | P | Cardinality | Description | Applicability |

| | | | | |
|---|---|---|---|---|
| UeStateIndReq | UeStateIndRequest | C | 0 . . . 1 | A request for UE Policies. Shall |
| | | | | be provided when the AMF |
| | | | | receives an “UE STATE |
| | | | | INDICATION” message, as |
| | | | | defined in Annex D.5.4 of |
| | | | | 3GPP TS 24.501. |

The existing attribute, pduSessionId, in type SmPolicyContextData in Table 5.6.2.3-1 of 3GPP TS 29.512 may need to be added to type SmPolicyUpdateContextData in Table 5.6.2.19-1 of 3GPP TS 29.512. The HTTP POST request may comprise Npcf_SMPolicyControl_Update, and may include EPS, user location, UE STATE INDICATION message.

At 577, the SM-PCF 530 based on the information provided by the SMF+PGW-C 528 determines that the UE handover's to EPS and the UE supports UE policy sections management list in the EPS. The SM-PCF 530 may check the UE's support for the UE policy section management list including receiving the URSP by the UE context policy control subscription information in UDR and based on that decides to establish a UE policy association towards the UE-PCF.

At 578 to 580, the SM-PCF 530 selects UE-PCF2 532 which may be different from the UE-PCF1 534 which was used when establishing the UE policy association at the time of the initial registration, to establish a new UE policy association in the EPS with. The new UE policy association is requested by the SM-PCF 530 by transmitting the UE STATE INDICATION message to the UE-PCF1 534. The stage 3 implementation of this transmission is described in 3GPP TS 29.525 v18.1.0.

At 581 to 591, the SMF+PGW-C 528 responds to the successful establishment of the default and the dedicated EPS bearers and the start of the routing packets to the SGW 526 and eventually to the UE 510 for those EPS bearers established.

At 592, the transferred PDU session is released as described in step 14 of FIG. 4.11.2.2-1 in 3GPP TS 23.502 v18.1.0.

At 593, the UE policy association which was established in 5GS at the time of initial registration is still kept.

At 594, the AMF 522 de-registers the UE 510 from the 5GS and deletes the UE policy association which was created at the time for the UE registration to the 5GS.

At 595, the SM-PCF 530 and UE-PCF1 534 may transmit the UE policy section management list as described in 3GPP TS 24.501 v18.1.0.

Accordingly, there is provided a wireless communication device, comprising: a processor; and a memory coupled with the processor. The processor is configured to cause the wireless communication device to: transmit, to a first network function, an information element, the information element comprising: a first container comprising a UE STATE INDICATION message; and a second container comprising a PDU session identity. The UE STATE INDICATION message comprises an UPSI list; and an indication for ANDSP support. The information element indicates that a PDU session identified by the PDU session identity is to be transferred from a first mobile communications technology to a second communications technology.

The first network function may be an SMF+PGW-C. The UE STATE INDICATION message may comprise a handover request. The PDU session identity may comprise a PDU session ID. The wireless communication device may be a User Equipment (UE).

The UE STATE INDICATION message may be contained in an extended protocol configuration options (ePCO). An extended protocol configuration options (ePCO) may contain the UE STATE INDICATION message. An ePCO may comprise two containers; one container containing the UE STATE INDICATON message and the other container containing the PDU session ID.

The UE STATE INDICATION message may further comprise one or more supported Operating System Identities (OSIds).

The first network function may be an SMF+PGW-C.

The first mobile communications technology may be 5GS. The second mobile communications technology may be EPS.

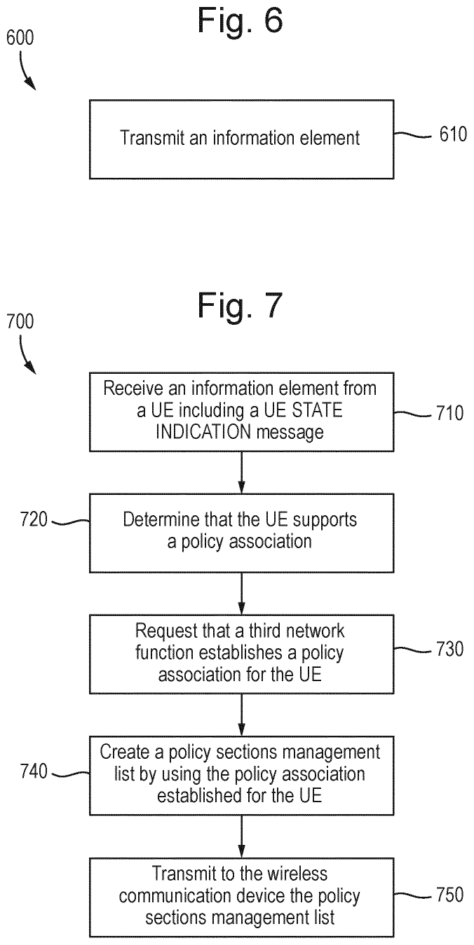

FIG. 6 illustrates a method 600 in a wireless communication device, the method 600 comprising: transmitting 610, to a first network function, an information element, the information element comprising: a first container comprising a UE STATE INDICATION message, and a second container comprising a PDU session identity. The UE STATE INDICATION message comprises an UPSI list and an indication for ANDSP support. The information element indicates that a PDU session identified by the PDU session identity is to be transferred from a first mobile communications technology to a second communications technology.

In certain embodiments, the method 600 may be performed by a processor executing program code, for example, a microcontroller, a microprocessor, a CPU, a GPU, an auxiliary processing unit, a FPGA, or the like.

The first network function may be an SMF+PGW-C. The UE STATE INDICATION message may comprise a handover request. The PDU session identity may comprise a PDU session ID. The wireless communication device may be a User Equipment (UE).

The UE STATE INDICATION message may be contained in an extended protocol configuration options (ePCO). An extended protocol configuration options (ePCO) may contain the UE STATE INDICATION message. An ePCO may comprise two containers; one container containing the UE STATE INDICATON message and the other container containing the PDU session ID.

The UE STATE INDICATION message may further comprise one or more supported Operating System Identities (OSIds).

The first network function may be an SMF+PGW-C.

The first mobile communications technology may be 5GS. The second mobile communications technology may be EPS.

There is further provided a second network function, comprising: a processor; and a memory coupled with the processor. The processor is configured to cause the second network function to: receive, from a wireless communication device, an information element, the information element comprising a first container comprising a UE STATE INDICATION message and a second container comprising a PDU session identity, wherein the UE STATE INDICATION message comprises an UPSI list and an indication for ANDSP support. The processor is further configured to cause the second network function to determine that the wireless communication device supports a policy association; request that a third network function establishes a policy association for the wireless communication device; create a policy sections management list by using the policy association established for the wireless communication device; and transmit to the wireless communication device the policy sections management list.

The information element may be received from the wireless communication device via a first network function. The information element may comprise an ePCO. The policy sections management list may be transmitted to the wireless communication device via the first network entity. The first network function may be an SMF+PGW-C.

The processor may be further arranged to create a policy sections management list by the third network function by using the policy association established for the wireless communication device.

The UE STATE INDICATION message may be contained in an extended protocol configuration options (ePCO). An extended protocol configuration options (ePCO) may contain the UE STATE INDICATION message. The UE STATE

INDICATION message may further comprise one or more supported Operating System Identities.

The second network function may be an SM-PCF. The third network function may be a UE-PCF.

The first mobile communications technology may be 5GS. The second mobile communications technology may be EPS.

FIG. 7 illustrates a method 700 in a second network function, the method 700 comprising: receiving 710, from a wireless communication device, an information element, the information element comprising a first container comprising a UE STATE INDICATION message and a second container comprising a PDU session identity, wherein the UE STATE INDICATION message comprises an UPSI list, and an indication for ANDSP support. The method further comprises: determining 720 that the wireless communication device supports a policy association; requesting 730 that a third network function establishes a policy association for the wireless communication device; creating 740 a policy sections management list by using the policy association established for the wireless communication device; and transmitting 750 to the wireless communication device the policy sections management list.

In certain embodiments, the method 700 may be performed by a processor executing program code, for example, a microcontroller, a microprocessor, a CPU, a GPU, an auxiliary processing unit, a FPGA, or the like.

The information element may be received from the wireless communication device via a first network function. The policy sections management list may be transmitted to the wireless communication device via the first network entity. The first network function may be an SMF+PGW-C.

The method may further comprise creating a policy sections management list by the third network function by using the policy association established for the wireless communication device.

The UE STATE INDICATION message may be contained in an extended protocol configuration options (ePCO). The UE STATE INDICATION message may further comprise one or more supported Operating System Identities. An extended protocol configuration options (ePCO) may contain the UE STATE INDICATION message.

The second network function may be an SM-PCF. The third network function may be a UE-PCF.

The first mobile communications technology may be 5GS. The second mobile communications technology may be EPS.

Accordingly, at the time of handover from the 5GS to the EPS, if the UE supports the UE policy section management list, the UE performs the UE initiated UE state indication procedure by inserting the UE STATE INDICATION message in the attach request. Upon receipt of the UE STATE INDICATION message, the SM-PCF realizes that it needs to request UE-PCF1 for the UE policy association to be established. The new UE policy association may be different from the existing UE policy association which was established at the time of 5GS registration.

At the time of handover from the 5GS to the EPS where one or more sessions are transferred without N26 reference point, if the UE supports the UE policy section management list, the UE policy association needs to be established in the EPS and the old UE policy association which was established at the time of the 5GS initial registration needs to be removed.

At the time of attach to the EPS, the UE needs to transmit the UE STATE INDICATION and the identities of the one or more sessions which are to be transferred towards the SMF+PGW-C which triggers that the SM-PCF requests the UE-PCF1 (which may be different from the UE-PCF2 which established the UE policy association at the time of the UE 5GS registration), to establish the new UE policy association.

Upon UE's attach request to the EPS when the UE hands-over from 5GS to EPS without N26 reference point, the UE initiates the UE-initiated UE state indication procedure by including the UE STATE INDICATION message in an extended protocol configuration options (ePCO). The UE also includes the PDU session ID of the one or more PDU sessions which are to be transferred to the EPS. The UE sends the ePCO within the PDN connectivity request towards the SMF+PGW-C, which due to the content of the ePCO realizes that the UE policy association needs to be established and one or more PDU sessions need to be transferred from the 5GS to the EPS.

Accordingly, there is provided a method comprising: transmitting by a device to a first network entity an information element comprising: a first container comprising a message; and a second container comprising an identity; wherein the information element indicates the first network entity a PDU session identified by the identity is to be transferred from a first mobile communications technology to a second communications technology. The method further comprises transmitting by the first network entity to a second network entity the message, wherein the second network determines that the device supports a policy association and requests a third network entity to establish the policy association for the device. The method further comprises creating a policy sections management list by the second network entity and the third network entity by using the policy association established for the device; and transmitting by the second network entity via the first network entity to the device, the policy sections management list.

The information element may be an extended protocol configuration options and the message is a UE STATE INDICATION message comprising: a UPSI list; an indication for ANDSP support; and possibly one or more supported OS Ids.

The first network entity may be an SMF+PGW-C. The second network entity may be an SM-PCF. The third network entity may be a UE-PCF The first mobile communications technology may be 5GS. The second mobile communications technology may be EPS.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: 5GCN, 5G Core Network; 5GS, 5G System; AMF, Access and Mobility Management Function;

ANDSP, Access Network Discovery and Selection Policy; API, Application Programming Interface; APN, Access Point Name; BRID, Broadcast Remote Identification; BVLOS, Beyond Visual Line of Sight; C2, Command and Control; CAA, Civil Aviation Administration; DCN, Dedicated Core Network; DNN, Data Network Name; DNS, Domain Name System; ePDG, evolved Packet Data Gateway; ePCO, Extended Protocol Configuration Options; EPS, Evolved Packet System; ER-NSSAI, Extended rejected NSSAI; E-UTRA, Evolved Universal Terrestrial Radio Access; FQDN, Fully Qualified Domain Name; GUMMEI, Globally Unique Mobility Management Entity Identifier; GUTI, Globally Unique Temporary Identity; HPLMN, Home PLMN; HSS, Home Subscriber Server; IE, Information Element; IMSI, International Mobile Subscriber Identity; IP, Internet Protocol; LADN, Local Area Data Network; LCS, LoCation Services; MCC, Mobile Country Code; MNC, Mobile Network Code; N3AN, Non-3GPP Access Network; N3IWF, Non-3GPP InterWorking Function; NEF, Network Exposure Function; NID, Network Identifier; OS, Operating System; OS Id, Operating System Identity; OS App Id, Operating System Application Identity; PCF, Policy Control Function; PCO, Protocol Configuration Options; PDN, Packet Data Network; PDN GW, PDN Gateway; PDU, Protocol Data Unit; PGW, PDN GW; PLMN, Public Land Mobile Network; PLMN ID, Public Land Mobile Network identity; PTI, Procedure Transaction Identity; MCC, Mobile Country Code; MME, Mobility Management Entity; MNC, Mobile Network Code; NF, Network Function; NID, Network Identifier; NRID, Networked Remote Identification; NSAC, Network Slice Admission Control; NSSF, Network Slice Selection Function; PTI, Procedure Transaction Identity; P-TMSI, Packet Temporary Mobile Subscriber Identity; RAI, Routing Area Identity; RID, Remote Identification; SWG, Serving Gateway; SMF, Session and Mobility Management Function; SM-PCO, Session Management PCO; SNPN, Standalone Non-Public Network; S-NSSAI, Single Network Slice Selection Assistance Information; SSC, Session and Service Continuity; SSID, Service Set Identifier; SUCI, Subscription Concealed Identifier; SUPI, Subscription Permanent Identifier; TA, Tracking Area; TAI, Tracking Area Identity; TAU, Tracking Area Update; TEID, Tunnel Endpoint Identifier; TNAN, Trusted Non-3GPP-Access-Network; TNAP, Trusted Non-3GPP Access Network; TNGF, Trusted Non-3GPP Gateway Function; TPAE, Third Party Authorized Entity; UAS, Uncrewed Aerial System; UAS NF, Uncrewed Aerial System Network Function; UAV, Uncrewed Aerial Vehicle; UAV-C, Uncrewed Aerial Vehicle Controller; UDM, Unified Data Management; UDR, Unified Data Repository; UE, User Equipment; UPDS, UE policy delivery service; UPSC, UE Policy Section Code; UPSI, UE Policy Section Identifier; URSP, UE Route Selection Policy; USIM, Universal Subscriber Identity Module; USS, UAS Service Supplier; UTM, Uncrewed Aerial System Traffic Management; UUAA, USS UAV Authorization/Authentication; UUID, Universal Unique Identifier; and WLANSP, Wireless Location Area Network Selection Policy.

1. A wireless communication device, comprising:
at least one memory; and
at least one processor coupled with the at least one memory and configured to cause the wireless communication device to:
transmit, to a network function, an information element (IE), the IE comprising:
a first container comprising a user equipment (UE) STATE INDICATION message, the UE STATE INDICATION message comprising a UE policy section identifier (UPSI) list and an indication for access network discovery and selection policy (ANDSP) support; and
a second container comprising a protocol data unit (PDU) session identity, wherein the IE indicates that a PDU session identified by the PDU session identity is to be transferred from a first mobile communications technology to a second communications technology.

2. The wireless communication device of claim 1, wherein the UE STATE INDICATION message is contained in an extended protocol configuration options (ePCO).

3. The wireless communication device of claim 1, wherein the UE STATE INDICATION message further comprises one or more supported Operating System Identities operating system identities (OSIds).

4. The wireless communication device of claim 1, wherein the first network function is session and mobility management function (SMF) and packet data network gateway-control (PGW-C).

5. A method performed by a wireless communication device, the method comprising:
transmitting, to a network function, an information element (IE), the IE comprising:
a first container comprising a user equipment (UE) STATE INDICATION message, the UE STATE INDICATION message comprising a UE policy section identifier (UPSI) list and an indication for access network discovery and selection policy (ANDSP) support; and
a second container comprising a protocol data unit (PDU) session identity, wherein the IE indicates that a PDU session identified by the PDU session identity is to be transferred from a mobile communications technology to a second communications technology.

6. The method of claim 5, wherein the UE STATE INDICATION message is contained in an extended protocol configuration options (ePCO).

7. The method of 6 claim 5, wherein the UE STATE INDICATION message further comprises one or more supported operating system identities (OSIds).

8. The method of claim 5, wherein the network function is session and mobility management function (SMF) and packet data network gateway-control (PGW-C).

9. A network function of a network node, the network node comprising:
at least one memory; and
at least one processor coupled with the at least one memory and configured to cause the network function to:
receive, from a wireless communication device, an information element (IE), the IE comprising a first container comprising a user equipment (UE) STATE INDICATION message and a second container comprising a protocol data unit (PDU) session identity, wherein the UE STATE INDICATION message comprises [: an] a UE policy section identifier (UPSI) list and an indication for access network discovery and selection policy (ANDSP) support;
determine that the wireless communication device supports a policy association;
request that a second network function establishes a policy association for the wireless communication device;
create a policy sections management list using the policy association established for the wireless communication device; and
transmit, to the wireless communication device, the policy sections management list.

10. The network function of claim 9, wherein the at least one processor is configured to cause the network function to create the policy sections management list by the second network function using the policy association established for the wireless communication device.

11. The network function of claim 9, wherein the UE STATE INDICATION message is contained in an extended protocol configuration options (ePCO).

12. The network function of claim 9, wherein the UE STATE INDICATION message further comprises one or more supported operating system identities (OSIds).

13. The network function of claim 9, wherein the network function is a session management policy control function (SM-PCF).

14. The network function of claim 9, wherein the second network function is a user equipment policy control function (UE-PCF).

15. A method performed by a network function, the method comprising:
receiving, from a wireless communication device, an information element (IE), the IE comprising a first container comprising a user equipment (UE) STATE INDICATION message and a second container comprising a protocol data unit (PDU) session identity, wherein the UE STATE INDICATION message comprises a UE policy section identifier (UPSI) list and an indication for access network discovery and selection policy (ANDSP) support;
determining that the wireless communication device supports a policy association;
requesting that a second network function establishes a policy association for the wireless communication device;
creating a policy sections management list using the policy association established for the wireless communication device; and
transmitting, to the wireless communication device, the policy sections management list.

16. The method of claim 15, further comprising creating the policy sections management list by the second network function using the policy association established for the wireless communication device.

17. The method of claim 15, wherein the UE STATE INDICATION message is contained in an extended protocol configuration options (ePCO).

18. The method of claim 15, wherein the UE STATE INDICATION message further comprises one or more supported operating system identities (OSIds).

19. The method of claim 15, wherein the network function is a session management policy control function (SM-PCF).

20. The method of claim 15, wherein the second network function is a user equipment policy control function (UE-PCF).
